(19) United States
(12) Patent Application Publication
(10) Pub. No.: US 2024/0381373 A1
(43) Pub. Date: Nov. 14, 2024

(54) DETERMINING A RESOURCE BASED ON A RESOURCE ASSIGNMENT

(71) Applicant: Lenovo (Singapore) Pte. Ltd., New Tech Park (SG)

(72) Inventors: Hossein Bagheri, Urbana, IL (US); Hyejung Jung, Northbrook, IL (US); Ankit Bhamri, Rödermark (DE); Karthikeyan Ganesan, Kronberg im Taunus (DE); Joachim Löhr, Wiesbaden (DE); Alexander Golitschek Edler von Elbwart, Darmstadt (DE); Vijay Nangia, Woodridge, IL (US)

(21) Appl. No.: 18/293,175

(22) PCT Filed: Jul. 27, 2022
(86) PCT No.: PCT/IB2022/056963

§ 371 Date: Jan. 29, 2024

Related U.S. Application Data
(60) Provisional application No. 63/226,669, filed on Jul. 28, 2021.

(51) Int. Cl. H04W 72/232; H04L 5/00; H04W 72/50

(52) U.S. Cl. CPC H04W 72/232; H04L 5/0055; H04W 72/50

(57) ABSTRACT

Apparatuses, methods, and systems are disclosed for determining a resource based on a resource assignment. One method includes receiving, at a UE, a first DL transmission in a first resource. The method includes, in response to receiving the first DL transmission, determining: a second resource based on a first DCI that assigns resources for the first DL transmission; a cut-off time, wherein a set of DL transmissions determined prior to the cut-off time and after the first DL transmission are considered elements of a set of potential subsequent DL occasions; and a third resource for transmitting an acknowledgment corresponding to the first DL transmission based on the second resource and the set of potential subsequent DL occasions. The method includes transmitting the acknowledgment in the third resource.

### CROSS-REFERENCE TO RELATED APPLICATIONS

This application claims priority to U.S. Patent Application Ser. No. 63/226,669 entitled “APPARATUSES, METHODS, AND SYSTEMS FOR TRANSMISSION RECEPTION ALIGNMENT FOR EXTENDED REALITY SERVICE” and filed on Jul. 28, 2021 for Hossein Bagheri et al., which is incorporated herein by reference in its entirety.

### FIELD

The subject matter disclosed herein relates generally to wireless communications and more particularly relates to determining a resource based on a resource assignment.

### BACKGROUND

In certain wireless communications networks, excessive power consumption may be made as a result of timing between uplink and downlink resources. In such networks, power consumption can be reduced.

### BRIEF SUMMARY

Methods for determining a resource based on a resource assignment are disclosed. Apparatuses and systems also perform the functions of the methods. One embodiment of a method includes receiving, at a UE, a first DL transmission in a first resource. In some embodiments, the method includes, in response to receiving the first DL transmission, determining: a second resource based on a first DCI that assigns resources for the first DL transmission; a cut-off time, wherein a set of DL transmissions determined prior to the cut-off time and after the first DL transmission are considered elements of a set of potential subsequent DL occasions; and a third resource for transmitting an acknowledgment corresponding to the first DL transmission based on the second resource and the set of potential subsequent DL occasions. In certain embodiments, the method includes transmitting the acknowledgment in the third resource.

One apparatus for determining a resource based on a resource assignment includes a receiver to receive a first DL transmission in a first resource. In some embodiments, the apparatus includes a processor to, in response to receiving the first DL transmission, determine: a second resource based on a first DCI that assigns resources for the first DL transmission; a cut-off time, wherein a set of DL transmissions determined prior to the cut-off time and after the first DL transmission are considered elements of a set of potential subsequent DL occasions; and a third resource for transmitting an acknowledgment corresponding to the first DL transmission based on the second resource and the set of potential subsequent DL occasions. In various embodiments, the apparatus includes a transmitter to transmit the acknowledgment in the third resource.

Another embodiment of a method for determining a resource based on a resource assignment includes transmitting, from a network device, a first DL transmission in a first resource. In response to transmitting the first DL transmission: a second resource is determined based on a first DCI that assigns resources for the first DL transmission; a cut-off time is determined, wherein a set of DL transmissions determined prior to the cut-off time and after the first DL transmission are considered elements of a set of potential subsequent DL occasions; and a third resource is determined for transmitting an acknowledgment corresponding to the first DL transmission based on the second resource and the set of potential subsequent DL occasions. In some embodiments, the method includes receiving the acknowledgment in the third resource.

Another apparatus for determining a resource based on a resource assignment includes a transmitter to transmit a first DL transmission in a first resource. In response to transmitting the first DL transmission: a second resource is determined based on a first DCI that assigns resources for the first DL transmission; a cut-off time is determined, wherein a set of DL transmissions determined prior to the cut-off time and after the first DL transmission are considered elements of a set of potential subsequent DL occasions; and a third resource is determined for transmitting an acknowledgment corresponding to the first DL transmission based on the second resource and the set of potential subsequent DL occasions. In some embodiments, the apparatus includes a receiver to receive the acknowledgment in the third resource.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for determining a resource based on a resource assignment;

FIG. 2 is a schematic block diagram illustrating one embodiment of an apparatus that may be used for determining a resource based on a resource assignment;

FIG. 3 is a schematic block diagram illustrating one embodiment of an apparatus that may be used for determining a resource based on a resource assignment;

FIG. 4 is a timing block diagram illustrating one embodiment of HARQ-ACK resource determination for UL-DL alignment;

FIG. 5 is a timing block diagram illustrating another embodiment of HARQ-ACK resource determination for UL-DL alignment;

FIG. 6 is a timing block diagram illustrating one embodiment of a cut-off time;

FIG. 7 is a flow chart diagram illustrating one embodiment of a method for determining a resource based on a resource assignment; and

FIG. 8 is a flow chart diagram illustrating another embodiment of a method for determining a resource based on a resource assignment.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

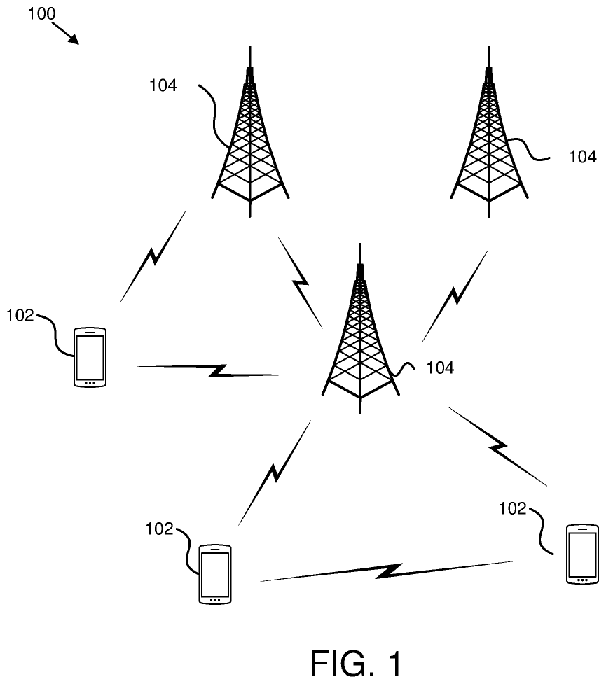

FIG. 1 depicts an embodiment of a wireless communication system 100 for determining a resource based on a resource assignment. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth R′, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive a first DL transmission in a first resource. In some embodiments, the remote unit 102 may, in response to receiving the first DL transmission, determine: a second resource based on a first DCI that assigns resources for the first DL transmission; a cut-off time, wherein a set of DL transmissions determined prior to the cut-off time and after the first DL transmission are considered elements of a set of potential subsequent DL occasions; and a third resource for transmitting an acknowledgment corresponding to the first DL transmission based on the second resource and the set of potential subsequent DL occasions. In certain embodiments, the remote unit 102 may transmit the acknowledgment in the third resource. Accordingly, the remote unit 102 may be used for determining a resource based on a resource assignment.

In certain embodiments, a network unit 104 may transmit a first DL transmission in a first resource. In response to transmitting the first DL transmission: a second resource is determined based on a first DCI that assigns resources for the first DL transmission; a cut-off time is determined, wherein a set of DL transmissions determined prior to the cut-off time and after the first DL transmission are considered elements of a set of potential subsequent DL occasions; and a third resource is determined for transmitting an acknowledgment corresponding to the first DL transmission based on the second resource and the set of potential subsequent DL occasions. In some embodiments, the network unit 104 may receive the acknowledgment in the third resource. Accordingly, the network unit 104 may be used for determining a resource based on a resource assignment.

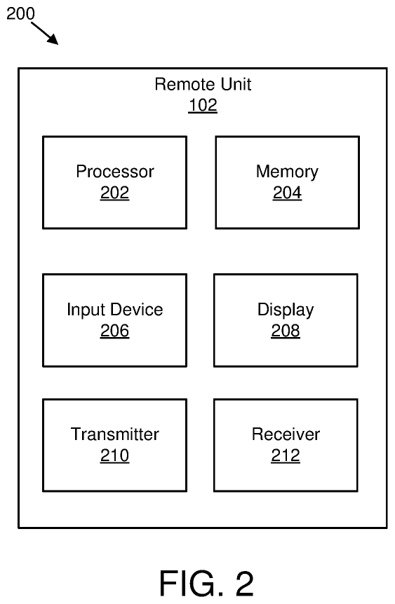

FIG. 2 depicts one embodiment of an apparatus 200 that may be used for determining a resource based on a resource assignment. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212 to receive a first DL transmission in a first resource. In some embodiments, the processor 202 to, in response to receiving the first DL transmission, determine: a second resource based on a first DCI that assigns resources for the first DL transmission; a cut-off time, wherein a set of DL transmissions determined prior to the cut-off time and after the first DL transmission are considered elements of a set of potential subsequent DL occasions; and a third resource for transmitting an acknowledgment corresponding to the first DL transmission based on the second resource and the set of potential subsequent DL occasions. In various embodiments, the transmitter 210 to transmit the acknowledgment in the third resource.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

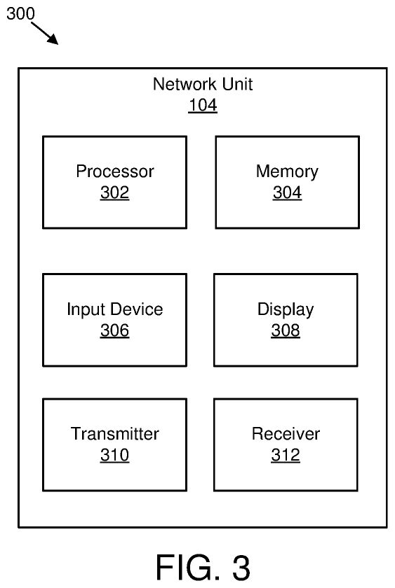

FIG. 3 depicts one embodiment of an apparatus 300 that may be used for determining a resource based on a resource assignment. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transmitter 310 transmits a first DL transmission in a first resource. In response to transmitting the first DL transmission: a second resource is determined based on a first DCI that assigns resources for the first DL transmission; a cut-off time is determined, wherein a set of DL transmissions determined prior to the cut-off time and after the first DL transmission are considered elements of a set of potential subsequent DL occasions; and a third resource is determined for transmitting an acknowledgment corresponding to the first DL transmission based on the second resource and the set of potential subsequent DL occasions. In some embodiments, the receiver 312 to receive the acknowledgment in the third resource.

It should be noted that one or more embodiments described herein may be combined into a single embodiment.

In certain embodiments, there may be a service-oriented design considering extended reality (“XR”) traffic characteristics (e.g., variable packet arrival rate: packets coming at 60-120 frames/second with some jitter, variable and large packet size) can enable more efficient (e.g., in terms of satisfying XR service requirements for a greater number of user equipments (“UEs”), or in terms of UE power saving) XR service delivery.

In some embodiments, to save a UE power, uplink (“UL”) transmissions may be sent and/or postponed (e.g., configured grant physical uplink shared channel (“PUSCH”) and/or hybrid automatic repeat request acknowledgment (“HARQ-ACK”) associated with a physical downlink shared channel (“PDSCH”) (e.g., semi-persistent scheduling (“SPS”) PDSCH)) to be as close as possible to a subsequent downlink (“DL”) transmission occasion (e.g., subsequent SPS occasion).

In various embodiments, there may be mechanisms to reduce UE power consumption. In such embodiments, the following mechanisms may be used: 1) mechanisms to determine a subsequent DL transmission occasion to which a HARQ-ACK of a first DL transmission is to be aligned with; and/or 2) mechanisms to determine a cut-off time after which DL transmission occasions are not included in a set of candidate subsequent DL transmission occasions from which a subsequent DL transmission occasion is determined.

In certain embodiments, there may be UL-DL alignment. In such embodiments, UL activity may be aligned, shifted, and/or localized around DL activity. Spreading UL and DL activities may leave less chance for a modem to go to a sleep mode as more on-time is needed for the modem. In addition, there may be transient times for power warm-up and ramp-down at the beginning and/or end of each UL and/or DL activity. Moreover, each UL and/or DL activity might extend discontinuous reception (“DRX”) timers (e.g., such as a DRX inactivity timer) which in turn leads to more power consumption. Furthermore, in such embodiments: 1) physical uplink shared channel (“PUSCH”) periodicity may configure and/or adapt a scheduling resource (“SR”) and/or configured grant (“CG”) such that it is more aligned with XR traffic periodicity, and happening around DL activity (e.g., such as a start of a DRX on-duration); and/or 2) DRX timer extensions may be limited due to UL activity dynamically and/or semi-statically.

In some embodiments, more frequent (e.g., pseudo) periodic UL pose and/or control transmissions may be compared to (pseudo) periodic DL. In such embodiments, HARQ-ACK and/or channel state information (“CSI”) reporting may be aligned with UL pose and/or control transmission occasions.

In various embodiments: 1) there may be downlink control information (“DCI”) based limitation of hybrid automatic repeat request (“HARQ”) retransmissions in the uplink for a last packet of a video frame; 2) CG PUSCH (“CG-PUSCH”) and/or SPS is confined within a DRX active time or physical downlink control channel (“PDCCH”) monitoring duration; 3) HARQ-ACK for dynamically scheduled PDSCH transmission may be aligned with DL reception via gNB scheduling, but when a DL grant is sent, gNB may not have a decision on a subsequent PUSCH and/or PDSCH scheduling, so HARQ-ACK for PDSCH may not be time aligned with PDSCH and/or PUSCH transmission; and/or 4) HARQ-ACK feedback may be deferred until a time close to a subsequent DL reception occasion. It should be noted that UL-DL alignment may be achieved to some degree by proper scheduling and/or network implementation.

In certain embodiments, there may be HARQ-ACK deferral. In such embodiments, HARQ-ACK deferral is supported to handle frequent HARQ-ACK dropping due to HARQ-ACK collision with DL. In that case, SPS HARQ-ACK instead of being dropped due to time division duplexing (“TDD”) specific collisions, is deferred until a next available physical uplink control channel (“PUCCH”) based on a semi-static configuration of a slot format.

In some embodiments, the following may be determined: 1) possible conditions for deferring HARQ-ACK; and/or 2) whether semi-statically configured flexible symbols are considered for PUCCH availability.

As used herein, a time unit may be a slot, subslot, and/or symbol. Instead of “slot”, “mini-slot”, “subslot” or “aggregated slots” may also be used. Several embodiments are described herein. According to a possible embodiment, one or more elements or features from one or more described embodiments may be combined.

In various embodiments, there may be mechanisms to determine a deferred HARQ-ACK resource.

In one embodiment of a HARQ-ACK deferral procedure: 1) a UE receives a first DL transmission in a first DL resource; 2) in response to receiving the first DL transmission, the UE determines, a) a first UL resource based on DCI scheduling the first DL transmission (e.g., PDSCH) or activation DCI associated with SPS transmissions including the first DL transmission, and b) a second UL resource for transmitting a HARQ-ACK (e.g., acknowledgment) corresponding to the first DL transmission that is being within l1 time units and/or symbols with respect to a second DL resource, wherein the second DL resource is after the first DL resource; and 3) transmitting the acknowledgment in the second UL resource.

In an example, a UE determines a second DL resource among DL resources, wherein the UE has detected and/or decoded a DL transmission. For instance. SPS occasions where no DL transmissions occur would not be considered as candidates for the second DL resource (e.g., if the UE is configured to skip HARQ-ACK feedback when DL transmission on a SPS PDSCH occasion is not detected). Such restriction may help achieve more power saving gain through UL-DL alignment as the UE may have a special low-power receiver to detect DL activity (e.g., DL transmissions), and, therefore, the UE may not need to warm up its main transceiver chain.

In one implementation, a UE receives a first HARQ-ACK deferral configuration for SPS PDSCH HARQ-ACK deferral in an unpaired spectrum, wherein the UE performs SPS PDSCH HARQ-ACK deferral based on the first HARQ-ACK deferral configuration if a PUCCH resource for SPS PDSCH HARQ-ACK feedback in a slot (or sub-slot) is not available. The PUCCH resource is based on a semi-static configuration (e.g., SPS PDSCH configuration) or based on the last detected DCI format indicating the HARQ-ACK feedback in the slot (or sub-slot).

In certain embodiments, a UE receives a second HARQ-ACK deferral configuration for power saving, where the UE performs HARQ-ACK deferral of a first PDSCH based on the second HARQ-ACK deferral configuration irrespective of availability of a PUCCH resource for HARQ-ACK feedback of the first PDSCH, if the second HARQ-ACK deferral configuration is received and/or if scheduling DCI or activation DCI indicates HARQ-ACK deferral for the first PDSCH. For performing HARQ-ACK deferral of the first PDSCH, the UE determines a second PDSCH as the latest PDSCH (e.g., determined based on SPS PDSCH configuration or based on detected DCI format) for which HARQ-ACK feedback occurs within a time limit that is determined based on a configured maximum HARQ-ACK deferral time and a PDSCH occasion corresponding to the first PDSCH. In one example, HARQ-ACK information of all PDSCHs and/or SPS release DCI occurring from the first PDSCH to the second PDSCH is transmitted together in a PUCCH or a PUSCH. A PUCCH resource for the PUCCH is determined based on the latest detected DCI format among detected DCI formats corresponding to PDSCHs and/or SPS release DCI occurring from the first PDSCH to the second PDSCH. If all the PDSCHs from the first PDSCH to the second PDSCH are SPS PDSCHs, the PUCCH resource is selected from semi-statically configured PUCCH resources based on a size of HARQ-ACK information bits.

In one example, a second UL resource can carry HARQ-ACK for PDSCHs occurring after and/or before a first DL transmission. In another example, if the first DL transmission also triggers a CSI report, the CSI report is also transmitted in a second UL resource.

In one embodiment: 1) a UE receives a first DL transmission in a first DL resource; 2) in response to receiving the first DL transmission, the UE determines a) a first UL resource based on DCI scheduling the first DL transmission (e.g., PDSCH) or activation DCI associated with SPS transmissions including the first DL transmission, and b) a second UL resource for transmitting a HARQ-ACK (e.g., acknowledgment) corresponding to the first DL transmission that is being within l2 time units and/or symbols with respect to a third UL resource, wherein the third UL resource is after the first DL resource; and/or 3) transmitting the acknowledgment in the second UL resource.

In another embodiment: 1) a UE receives a first DL transmission in a first DL resource; 2) in response to receiving the first DL transmission, the UE determines a) a first UL resource based on DCI scheduling the first DL transmission (e.g., PDSCH) or activation DCI associated with SPS transmissions including the first DL transmission, b) a set of candidate DL resources (e.g., the set at least includes one DL resource), wherein each DL resource of the set of candidate DL resources ends later than the first DL resource, and c) a second UL resource for transmitting a HARQ-ACK (e.g., acknowledgment) corresponding to the first DL transmission that is being within l1 time units and/or symbols with respect to a second DL resource, wherein the second DL resource is selected from the set of candidate DL resources; and/or 3) transmitting the acknowledgment in the second UL resource.

In one implementation, a UE determines a second DL transmission based on a duration and/or span of each of the DL resources of a set of candidate DL resources.

In one example, a set of candidate DL resources includes a first DL resource candidate and a second DL resource candidate. The first DL resource candidate occupies a complete and/or whole first slot, whereas the second DL resource candidate occupies a portion of a second slot (e.g., 4 consecutive symbols in the beginning of the second slot). The UE may determine the second DL resource to be the second DL resource candidate if there is an UL resource confined within the second slot in which the HARQ-ACK (and/or acknowledgment) corresponding to the first DL transmission can be sent (e.g., subject to satisfying any gap requirement, such as l1).

In some embodiments: 1) a UE receives a first DL transmission in a first DL resource; 2) in response to receiving the first DL transmission, the UE determines: i) a first UL resource based on DCI scheduling the first DL transmission (e.g., PDSCH) or activation DCI associated with SPS transmissions including the first DL transmission, ii) a set of candidate DL resources (e.g., the set at least includes one DL resource), wherein each DL resource of the set of candidate DL resources ends later than the first DL resource, iii) a set of candidate UL resources (e.g., the set at least includes one UL resource), wherein each UL resource of the set of candidate UL resources ends later than the first DL resource, and iv) a second UL resource for transmitting a HARQ-ACK (acknowledgment) corresponding to the first DL transmission that is being within l1 time units and/or symbols with respect to either a) a second DL resource, wherein the second DL resource is selected from the set of candidate DL resources or b) a third UL resource, wherein the third UL resource is selected from the set of candidate UL resources; and/or 3) transmitting the acknowledgment in the second UL resource.

In various embodiments: 1) a UE receives a first DL transmission in a first DL resource; 2) in response to receiving the first DL transmission, the UE determines: i) a first UL resource based on DCI scheduling the first DL transmission (e.g., PDSCH) or activation DCI associated with SPS transmissions including the first DL transmission, ii) a set of candidate DL resources (e.g., the set at least includes one DL resource), wherein each DL resource of the set of candidate DL resources ends later than the first DL resource, iii) a set of candidate UL resources (e.g., the set at least includes one UL resource), wherein each UL resource of the set of candidate UL resources ends later than the first DL resource, and iv) a second UL resource for transmitting a HARQ-ACK (acknowledgment) corresponding to the first DL transmission that is being either a) within l1 time units and/or symbols with respect to a second DL resource, wherein the second DL resource is selected from the set of candidate DL resources or b) within l2 time units and/or symbols with respect to a third UL resource, wherein the third UL resource is selected from the set of candidate UL resources; and/or 3) transmitting the acknowledgment in the second UL resource.

In certain embodiments: 1) a UE receives a first DL transmission in a first DL resource; 2) in response to receiving the first DL transmission, the UE determines: i) a first UL resource based on DCI scheduling the first DL transmission (e.g., PDSCH) or activation DCI associated with SPS transmissions including the first DL transmission (in an example, the DCI indicates PDSCH-to-HARQ_feedback timing k1, and the first UL resource is determined based on k1 slots, symbols, and/or subslots from the first DL transmission (e.g., PDSCH)), ii) a cut-off time wherein all scheduled and configured DL transmission occasions for the UE (e.g., over different serving cells) prior to the cut-off time (or up to and including the cut-off time) and after the first DL transmission are considered as elements of a set of potential subsequent DL occasions D associated with the first DL transmission a) alternatively, a cut-off time wherein all scheduled and configured DL transmissions for the UE (e.g., over different serving cells) for which their corresponding scheduling DCI or activation DCI (e.g., for configured transmissions) is received prior to the cut-off time (or up to and including the cut-off time) and after the first DL transmission are considered as elements of the set of potential subsequent DL occasions D associated with the first DL transmission, b) alternatively determining a set of potential subsequent DL occasions D associated with the first DL transmission can be e.g., based on a cut-off time, an indication received in DCI scheduling the first DL transmission (e.g., PDSCH) or activation DCI associated with SPS transmissions including the first DL transmission, or an indication received in a higher-layer configuration (e.g., such as PDSCH configuration and/or SPS configuration. For instance, the higher layer configuration can indicate the first and/or last ‘x’ DL occasions in a window of time with respect to the first DL transmission can be considered to construct and/or determine D)—the window can be defined in specifications, indicated (e.g., by RRC), or determined per SCS or for a reference SCS (e.g., lowest and/or highest among the DL component carriers (“CCs”) being considered for constructing and/or determining D), iii) a second DL resource from the set of potential subsequent DL occasions D such that the second DL resource is the earliest available and/or valid DL resource after the 1st UL resource, iv) a third DL resource from the set of potential subsequent DL occasions D such that the third DL resource is the latest available and/or valid DL resource before the 1st UL resource, and v) a 2nd UL resource for transmitting a HARQ-ACK (e.g., acknowledgment) corresponding to the first DL transmission based on one or more of the 1st UL resource, the 2nd DL resource, and the 3rd DL resource; and/or 3) transmitting the acknowledgment in the 2nd UL resource.

In some examples of the embodiment, an uplink resource (e.g., PUCCH and/or PUSCH resource) associated with the 2nd DL resource, and an uplink resource associated with the 3rd DL resource may be used instead of the 2nd DL resource, and the 3rd DL resource (e.g., in element (v)). For example, the associated uplink resource may be a HARQ-ACK resource associated with the 2nd DL and/or 3rd DL resource, or the associated uplink resource may be an uplink resource near (e.g., closest to, before, or after) the 2nd DL and/or 3rd DL resource and may satisfy any required multiplexing conditions and/or timelines.

In one embodiment, only a subset of one or more elements or features from another embodiment may be performed (e.g., 2nd DL and/or 3rd DL resource may be determined without an intermediate step of determining a set of potential subsequent DL occasions D, performing elements (1), 1(i), (iv), and (v), or performing elements (1), 1(i), (iii), and (v) in an embodiment above).

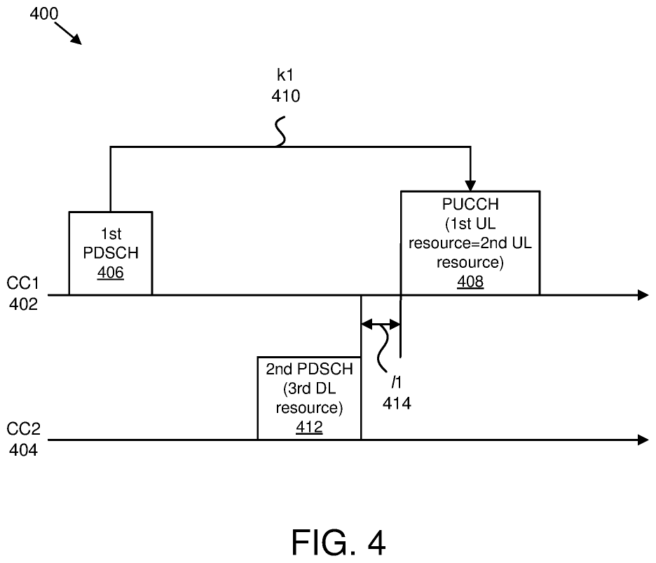

In one example, a UE determines a 2nd UL resource to be the 1st UL resource if a 3rd DL resource is at most ‘l₁’ time units before the 1st UL resource as shown in FIG. 4.

In another example, if an UL and/or sidelink (“SL”) transmission on an UL and/or SL resource (e.g., such as a random access channel (“RACH”) resource that the UE intends to transmit a RACH signal in or an UL resource corresponding to a high priority transmission) is scheduled and/or configured for the UE and the gap between the UL and/or SL resource and the 1st UL resource is at most ‘l₃’ time units, the UE determines the 2nd UL resource to be the 1^{st} UL resource. In an example, ‘l₃=l₁’. In one example, the UL and/or SL resource occurs before and/or after the 1st UL resource.

FIG. 4 is a timing block diagram 400 illustrating one embodiment of HARQ-ACK resource determination for UL-DL alignment. The timing block diagram 400 includes a first CC 402 (“CC1”) and a second CC 404 (“CC2”). A 1st PDSCH 406 and a PUCCH 408 are communicated over CC1 402. The PUCCH 408 is indicated by k1 410. A 2nd PDSCH 412 is communicated over CC2 404. A gap l1 414 is between the 2nd PDSCH 412 and the PUCCH 408. The PUCCH 408 resource indicated by k1 410 is the resource to be used as 1st and 2nd UL resource since the gap 414 between the PUCCH 408 and the 3rd DL resource is at most l1 414. It should be noted that the scheduling DCIs for FIG. 4 are not illustrated.

In one example, a UE determines a 2nd UL resource to be an earliest available and/or valid UL resource that is at most ‘l₁’ time units after a 2nd DL resource.

In another example, an earliest available PUCCH resource for transmitting HARQ-ACK for a plurality of DL resources may be selected from a plurality of the PUCCH carriers based on an earliest availability in terms of uplink slots (e.g., slot format).

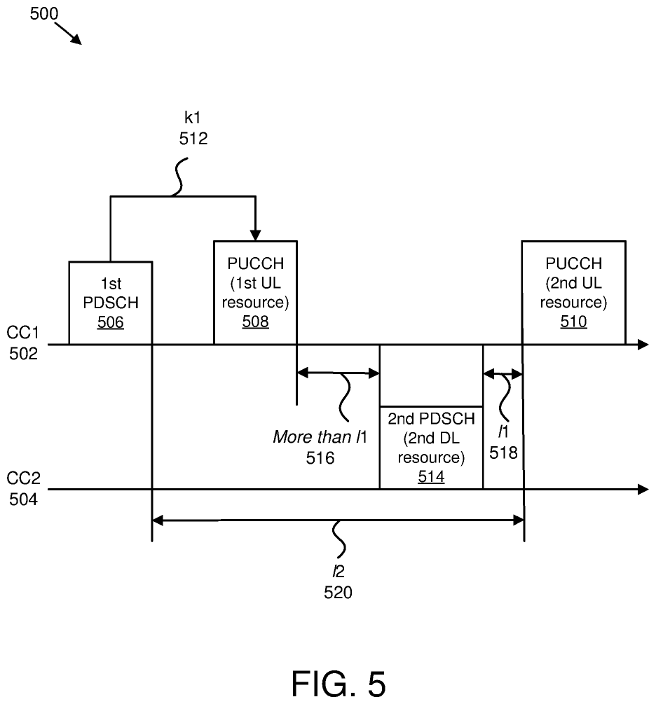

In a further example, a UE determines a 2nd UL resource to be an earliest available UL resource that is at most ‘l₁’ time units after a 2nd DL resource and no later than ‘l₂’ time units after (e.g., end of) a first DL transmission (e.g., the first DL resource) or after (e.g., end of) the 1st UL resource. This example is shown in FIG. 5.

FIG. 5 is a timing block diagram 500 illustrating another embodiment of HARQ-ACK resource determination for UL-DL alignment. The timing block diagram 500 includes a first CC 502 (“CC1”) and a second CC 504 (“CC2”). A 1st PDSCH 506, a PUCCH (1st UL resource) 508, and another PUCCH (2nd UL resource) 510 are communicated over CC1 502. The PUCCH 508 is indicated by k1 512. A 2nd PDSCH 514 is communicated over CC2 504. A gap more than l1 516 is between the PUCCH 508 and the 2nd PDSCH 514, and a gap l1 518 is between the 2nd PDSCH 514 and the PUCCH 510. Further a gap l2 520 is between the 1st PDSCH 506 and the PUCCH 510. The PUCCH 508 resource indicated by k1 512 (e.g., 1st UL resource) is not to be used for the HARQ-ACK feedback, but the 2nd UL resource 510 is used for HARQ-ACK for the 1st PDSCH 506 as the gap between the 2nd UL resource 510 and a DL transmission occasion (e.g., 2nd DL resource 514) is small. It should be noted that the scheduling DCIs are not shown in FIG. 5.

In certain embodiments: 1) a UE receives a first DL transmission in a first DL resource and a second DL transmission in a second DL resource, wherein the second DL transmission ends no later than ‘T’ time units after the end of the first DL transmission; 2) in response to receiving the first DL transmission, the UE determines: i) a first UL resource based on DCI scheduling the first DL transmission (e.g., PDSCH) or activation DCI associated with SPS transmissions including the first DL transmission, ii) a second UL resource for transmitting a HARQ-ACK (e.g., acknowledgment) corresponding to the first DL transmission that is being within l1 time units and/or symbols with respect to a third DL resource, wherein the third DL resource is after the first DL resource, and iii) transmitting the HARQ-ACK corresponding to the first DL transmission in the second UL resource; 3) in response to receiving the second DL transmission, the UE determines: i) a third UL resource based on DCI scheduling the second DL transmission (e.g., PDSCH) or activation DCI associated with SPS transmissions including the second DL transmission, and ii) if the second UL resource is after (or starts after or ends after) the third UL resource transmitting the HARQ-ACK corresponding to the second DL transmission in the second UL resource, and if the second UL resource is not after the third UL resource determining a fourth UL resource for transmitting a HARQ-ACK (e.g., acknowledgment) corresponding to the second DL transmission that is being within l1 time units and/or symbols with respect to a fourth DL resource, wherein the fourth DL resource is after the second DL resource; and/or 4) transmitting the HARQ-ACK corresponding to the second DL transmission in the fourth UL resource.

In one example, a minimum possible k1 value (e.g., if UL-DL alignment is enabled) is larger than a threshold. In another example, a threshold depends on a UE capability reporting such as PDSCH processing time or PUSCH preparation time.

In one embodiment: 1) a UE receives a first DL transmission in a first DL resource; 2) in response to receiving the first DL transmission, the UE determines: a) a first UL resource based on DCI scheduling the first DL transmission (e.g., PDSCH) or activation DCI associated with SPS transmissions including the first DL transmission; and b) a second UL resource for transmitting a HARQ-ACK (e.g., acknowledgment) corresponding to the first DL transmission that is within l1 time units and/or symbols with respect to a second DL resource, wherein the second DL resource is after the first DL resource; and/or 3) the UE determines if there are no other HARQ-ACK information associated with other DL transmissions than the first DL transmission (e.g., which could be sent along the HARQ-ACK corresponding to the 1st DL transmission in the 1st UL resource) exceeding their maximum HARQ-ACK deferral time if they are deferred to the second UL resource a) if yes: transmitting the HARQ-ACKs in the second UL resource, b) if no: transmitting the HARQ-ACKs in the first UL resource.

In one example, a maximum HARQ-ACK deferral time is determined for each DL transmission (e.g., in PDSCH configuration and/or SPS configuration).

In another example, whether a HARQ-ACK can be deferred (e.g., using 1st UL resource instead of 2nd UL resource) is determined per HARQ process and/or set of HARQ processes for each serving cell. One motivation may be to use the method in this example for certain traffic (e.g., XR service), and not spend processing time and/or power to perform the steps above for a traffic that performing such UL-DL alignment is not feasible and/or suitable for (e.g., ultra-reliable low-latency communication (“URLLC”) traffic where power saving through alignment may not be needed).

In certain examples, whether a HARQ-ACK can be deferred is indicated in DCI scheduling a first DL transmission (e.g., PDSCH) or activation DCI associated with SPS transmissions including the first DL transmission.

In various embodiments, there may be a cut-off time determination.

In certain embodiments related to another embodiment described herein, a cut-off time is determined based on one or more of the following: 1) a 1st UL resource (e.g., a configured (e.g., negative or non-negative) offset with respect to the 1st UL resource); 2) PDSCH-to-HARQ_feedback timing k1; 3) a first DL resource (e.g., the last symbol of the first PDSCH); 4) a radio resource control (“RRC”) message (e.g., a number of time units is indicated via RRC, a UE is indicated by a group index for a set of configured CCs—the UE determines the cut-off time based on the number of CCs within the group); 5) medium access control control element (“MAC-CE”) message; 6) a DCI indication; and/or 7) a first and/or earliest DCI occurring (e.g., across a set of CCs) after a) the start or end of the first DL transmission or b) the start or end of the 1st UL resource.

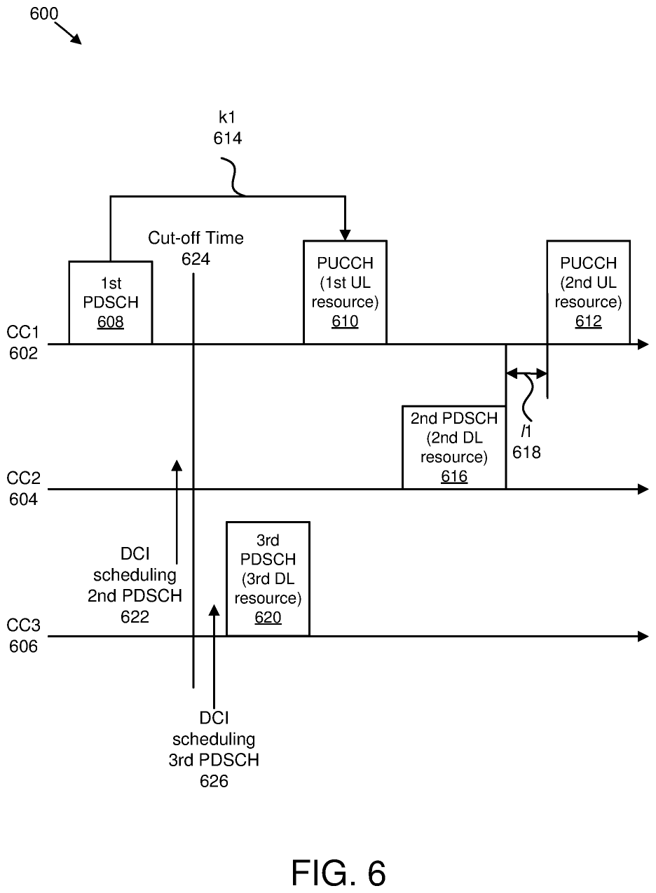

An example of impact of a cut-off time is shown in FIG. 6.

FIG. 6 is a timing block diagram 600 illustrating one embodiment of a cut-off time. The timing block diagram 600 includes a first CC 602 (“CC1”), a second CC 604 (“CC2”), and a third CC 606 (“CC3”). A 1st PDSCH 608, a PUCCH (1st UL resource) 610, and a PUCCH (2nd UL resource) 612 are communicated over CC1 602. The PUCCH 610 is indicated by k1 614. A 2nd PDSCH 616 is communicated over CC2 604. A gap l1 618 is between the 2nd PDSCH 616 and the PUCCH 612. A 3rd PDSCH 620 is communicated over CC3 606. A DCI scheduling 2nd PDSCH 622 occurs before a cut-off time 624, and a DCI scheduling 3rd PDSCH 626 occurs after the cut-off time 624. The 3rd PDSCH 620 is not considered in the set of potential DL transmission occasions for the purpose of UL-DL alignment as it is scheduled after the cut-off time. It should be noted that some scheduling DCIs are not shown in FIG. 6.

In one example, a cut-off time is used to determine a set of potential subsequent DL occasions D, and a set of potential subsequent UL occasions U. The UE considers UL resources of the set (as candidates for the 2nd UL resource if they satisfy any required multiplexing conditions and/or timelines.

In another example, separate cut-off times associated with D and U are determined. The cut-off times might be dependent on PDSCH processing time and PUSCH preparation time respectively for D and U. Each cut-off time can depend on a reference SCS (e.g., smallest and/or largest SCS amongst CCs for which the cut-off time is calculated and/or determined).

In a further example, a number and/or set of CCs for which the cut-off time is determined is a UE capability or RRC configured.

In certain embodiments, an alignment gap (l₁) is determined based on one or more of the following: 1) a UE capability signaling (e.g., ‘l₁’ can be defined and/or reported for a CC, for a set of CCs, per SCS); and/or 2) an indication (e.g., RRC, MAC-CE, DCI).

In some embodiments, a 2nd UL resource has the same priority as a 1st UL resource.

In various embodiments, if a UE receives an indication (e.g., SFI (slot format indicator)) canceling the earliest DL resource after the 1st UL resource or the latest DL resource before the 1st UL resource a certain time in advance (e.g., before the cut-off time), the UE determines a next earliest and/or a preceding latest DL resource.

In certain embodiments, a UE determines a 2nd UL resource for transmitting a HARQ-ACK (e.g., acknowledgment) corresponding to the first DL transmission to be a 1st UL resource if the indication is received earlier than a certain time (e.g., after the cut-off time).

In some embodiments, if a UE receives an UL cancellation (“CI”) indication, the UE determines the 2nd UL resource according to an embodiment herein and then checks if the 2nd UL resource is canceled. If the 2nd UL is determined to be canceled, the UE would drop the HARQ-ACK or would follow any semi-static HARQ-ACK deferral procedure (e.g., the UE would find a next available UL resource) and transmit the HARQ-ACK in that resource. In another embodiment, a UE determines a 2nd UL resource considering any cancelation indication (e.g., slot format indicator (“SFI”) and/or UL CI) if the cancelation indication is received a certain time in advance (e.g., before a cut-off time), the UE determines a next earliest UL resource that is close to a DL transmission occasion and would transmit the HARQ-ACK in the determined next earliest UL resource that is close to a DL transmission occasion.

In various embodiments, if a serving cell is activated, a determination of a 2nd UL resource is performed (e.g., at least for that serving cell) only after a certain (e.g., preconfigured) time after the MAC-CE activating the serving cell is received and/or acknowledged.

In certain embodiments, if a serving cell is activated, the serving cell's resources are not considered in determining a set of potential subsequent DL occasions, the 2nd DL resource, or the 3rd DL resource until after a certain (e.g., preconfigured) time after the MAC-CE activating the serving cell is received and/or acknowledged.

In some embodiments, UL-DL alignment (e.g., whether to apply one or more embodiments herein, or whether an UL transmission should be deferred to proximity of a DL transmission) can be enabled by an indication (e.g., DCI (e.g., scheduling DCI or group-common DCI), MAC-CE, or RRC signaling).

In one example, group common (“GC”) DCI (“GC-DCI”) is used to enable and/or disable UL-DL alignment for a set of CCs (e.g., each CC is individually enabled and/or disabled for UL-DL alignment), and UL-DL alignment is performed for the set of enabled CCs. In another example, an SPS activation command enables and/or disables UL-DL alignment.

In various embodiments, UL-DL alignment once enabled (e.g., via an indication) is valid and/or applicable for a duration of time ‘T’. In an example, ‘T’ is indicated by RRC, MAC-CE, and/or DCI signaling, UE capability signaling, or is fixed in a specification. In another example, ‘T’ is implicitly derived (e.g., based on a PDCCH monitoring periodicity (e.g., for GC-DCI indicating the set of enabled CCs)).

In one embodiment, a UE confirms reception of UL-DL alignment indication. In one example, the UE sends an indication to the network (e.g., in a first acknowledgment sent after reception of the indication).

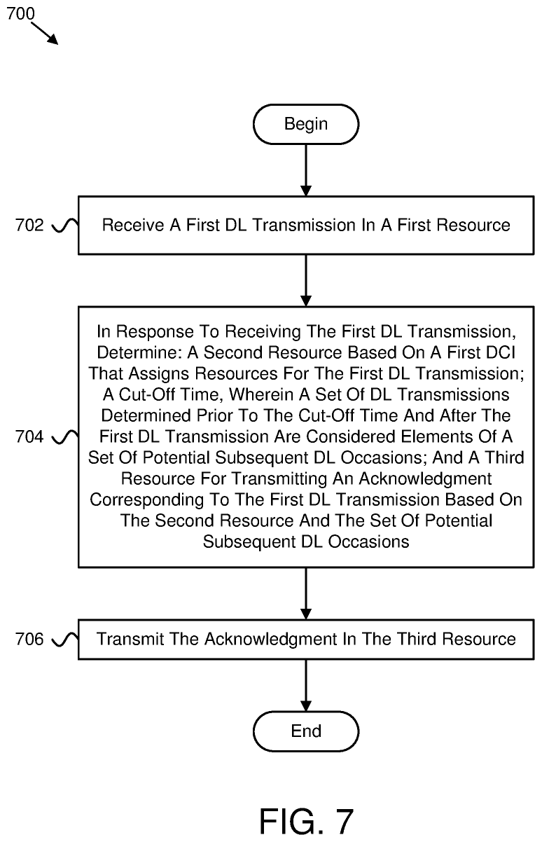

FIG. 7 is a flow chart diagram illustrating one embodiment of a method 700 for determining a resource based on a resource assignment. In some embodiments, the method 700 is performed by an apparatus, such as the remote unit 102. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes receiving 702, at a UE, a first DL transmission in a first resource. In some embodiments, the method 700 includes, in response to receiving the first DL transmission, determining 704: a second resource based on a first DCI that assigns resources for the first DL transmission; a cut-off time, wherein a set of DL transmissions determined prior to the cut-off time and after the first DL transmission are considered elements of a set of potential subsequent DL occasions; and a third resource for transmitting an acknowledgment corresponding to the first DL transmission based on the second resource and the set of potential subsequent DL occasions. In certain embodiments, the method 700 includes transmitting 706 the acknowledgment in the third resource.

In certain embodiments: a fourth resource from the set of potential subsequent DL occasions is determined such that the fourth resource is an earliest valid DL resource after the second resource; a fifth resource from the set of potential subsequent DL occasions is determined such that the fifth resource is a latest valid DL resource before the second resource; and the third resource is determined based on the second resource, the fourth resource, and the fifth resources. In some embodiments, the third resource is determined to be the second resource if the fifth resource is at most ‘l₁’ time units before the second resource. In various embodiments, the method 700 further comprises reporting a value of ‘l₁’.

In one embodiment, the third resource is determined to be the earliest valid UL resource that is at most ‘l₁’ time units after the fourth resource. In certain embodiments, the third resource is no later than ‘l₂’ time units after the second resource. In some embodiments, the method 700 further comprises receiving an indication indicating whether the third resource is determined based on the fourth resource and the fifth resource in addition to the second resource.

In various embodiments, the method 700 further comprises, in response to the indication indicating that the third resource is determined based on the fourth resource and the fifth resource in addition to the second resource, determining the third resource based on the second resource, the fourth resource, and the fifth resource. In one embodiment, the method 700 further comprises, in response to the indication not indicating that the third resource is determined based on the fourth resource and the fifth resource in addition to the second resource, determining the third resource based on the second resource and not based on the fourth resource and the fifth resource. In certain embodiments, the indication comprises a group-common DCI.

In some embodiments, the method 700 further comprises determining a time duration, wherein the indication is applicable for the time duration. In various embodiments, the time duration is determined to be a time interval between a first time instance and a second time instance, and the first time instance is determined based on a time that the indication is received. In one embodiment, if a second indication of the same type of the indication is received, the second time instance is determined to be the time that the second indication is received.

In certain embodiments, the method 700 further comprises sending a confirmation indication to a network device in response to receiving the indication. In some embodiments, the third resource and the fourth resource are in a slot of a reference slot duration. In various embodiments, the reference slot duration is associated with a longest slot duration among UL and DL transmissions.

In one embodiment, the first DL transmission is associated with a first HARQ process, and the acknowledgement corresponding to a second DL transmission associated with a second HARQ process is sent on an UL resource indicated by a second DCI scheduling the second DL transmission. In certain embodiments, the cut-off time is determined based on: the second resource; a PDSCH-to-HARQ feedback timing k1; the first resource; an indication; an earliest DCI occurring after the first DL transmission; or some combination thereof. In some embodiments, the method 700 further comprises determining a set of UL occasions prior to a second cut-off time, wherein the third resource is further determined based on the set of UL occasions.

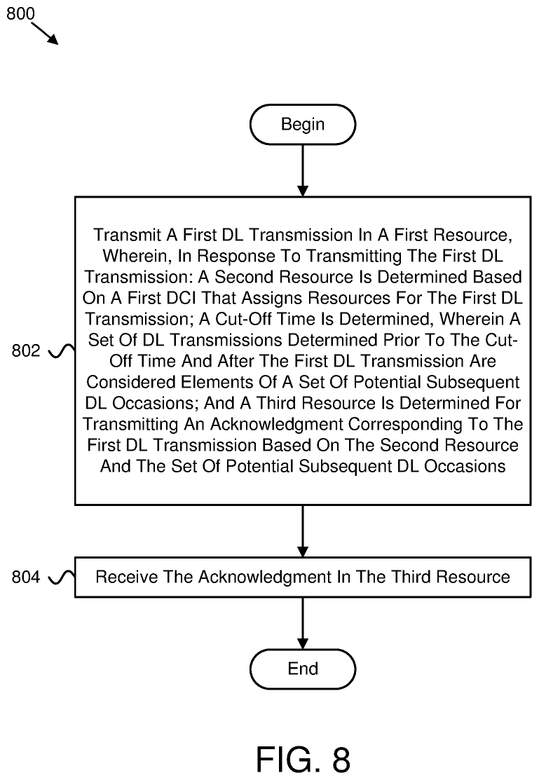

FIG. 8 is a flow chart diagram illustrating another embodiment of a method 800 for determining a resource based on a resource assignment. In some embodiments, the method 800 is performed by an apparatus, such as the network unit 104. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes transmitting 802, from a network device, a first DL transmission in a first resource. In response to transmitting the first DL transmission: a second resource is determined based on a first DCI that assigns resources for the first DL transmission; a cut-off time is determined, wherein a set of DL transmissions determined prior to the cut-off time and after the first DL transmission are considered elements of a set of potential subsequent DL occasions; and a third resource is determined for transmitting an acknowledgment corresponding to the first DL transmission based on the second resource and the set of potential subsequent DL occasions. In some embodiments, the method 800 includes receiving 804 the acknowledgment in the third resource.

In certain embodiments: a fourth resource from the set of potential subsequent DL occasions is determined such that the fourth resource is an earliest valid DL resource after the second resource; a fifth resource from the set of potential subsequent DL occasions is determined such that the fifth resource is a latest valid DL resource before the second resource; and the third resource is determined based on the second resource, the fourth resource, and the fifth resources. In some embodiments, the third resource is determined to be the second resource if the fifth resource is at most ‘l₁’ time units before the second resource. In various embodiments, the third resource is determined to be the earliest valid UL resource that is at most ‘l₁’ time units after the fourth resource.

In one embodiment, the third resource is no later than ‘l₂’ time units after the second resource. In certain embodiments, the method 800 further comprises transmitting an indication indicating whether the third resource is determined based on the fourth resource and the fifth resource in addition to the second resource. In some embodiments, the third resource and the fourth resource are in a slot of a reference slot duration.

In various embodiments, the reference slot duration is associated with a longest slot duration among UL and DL transmissions. In one embodiment, the first DL transmission is associated with a first HARQ process, and the acknowledgement corresponding to a second DL transmission associated with a second HARQ process is sent on an UL resource indicated by a second DCI scheduling the second DL transmission. In certain embodiments, the cut-off time is determined based on: the second resource; a PDSCH-to-HARQ feedback timing k1; the first resource; an indication; an earliest DCI occurring after the first DL transmission; or some combination thereof.

In one embodiment, an apparatus comprises: a receiver to receive a first DL transmission in a first resource; a processor to, in response to receiving the first DL transmission, determine; a second resource based on a first DCI that assigns resources for the first DL transmission; a cut-off time, wherein a set of DL transmissions determined prior to the cut-off time and after the first DL transmission are considered elements of a set of potential subsequent DL occasions; and a third resource for transmitting an acknowledgment corresponding to the first DL transmission based on the second resource and the set of potential subsequent DL occasions; and a transmitter to transmit the acknowledgment in the third resource.

In certain embodiments: a fourth resource from the set of potential subsequent DL occasions such that the fourth resource is an earliest valid DL resource after the second resource; a fifth resource from the set of potential subsequent DL occasions such that the fifth resource is a latest valid DL resource before the second resource; and the third resource is determined based on the second resource, the fourth resource, and the fifth resources.

In some embodiments, the third resource is determined to be the second resource if the fifth resource is at most ‘l₁’ time units before the second resource.

In various embodiments, the processor further to report a value of ‘l₁’.

In one embodiment, the third resource is determined to be the earliest valid UL resource that is at most ‘l₁’ time units after the fourth resource.

In certain embodiments, the third resource is no later than ‘l₂’ time units after the second resource.

In some embodiments, the receiver further to receive an indication indicating whether the third resource is determined based on the fourth resource and the fifth resource in addition to the second resource.

In various embodiments, in response to the indication indicating that the third resource is determined based on the fourth resource and the fifth resource in addition to the second resource, the processor further to determine the third resource based on the second resource, the fourth resource, and the fifth resource.

In one embodiment, in response to the indication not indicating that the third resource is determined based on the fourth resource and the fifth resource in addition to the second resource, the processor further to determine the third resource based on the second resource and not based on the fourth resource and the fifth resource.

In certain embodiments, the indication comprises a group-common DCI.

In some embodiments, the processor further to determine a time duration, and the indication is applicable for the time duration.

In various embodiments, the time duration is determined to be a time interval between a first time instance and a second time instance, and the first time instance is determined based on a time that the indication is received.

In one embodiment, if a second indication of the same type of the indication is received, the second time instance is determined to be the time that the second indication is received.

In certain embodiments, the transmitter is further to send a confirmation indication to a network device in response to receiving the indication.

In some embodiments, the third resource and the fourth resource are in a slot of a reference slot duration.

In various embodiments, the reference slot duration is associated with a longest slot duration among UL and DL transmissions.

In one embodiment, the first DL transmission is associated with a first HARQ process, and the acknowledgement corresponding to a second DL transmission associated with a second HARQ process is sent on an UL resource indicated by a second DCI scheduling the second DL transmission.

In certain embodiments, the cut-off time is determined based on: the second resource; a PDSCH-to-HARQ feedback timing k1; the first resource; an indication; an earliest DCI occurring after the first DL transmission; or some combination thereof.

In some embodiments, the processor further to determine a set of UL occasions prior to a second cut-off time, and the third resource is further determined based on the set of UL occasions.

In one embodiment, a method at a UE comprises: receiving a first DL transmission in a first resource; in response to receiving the first DL transmission, determining: a second resource based on a first DCI that assigns resources for the first DL transmission; a cut-off time, wherein a set of DL transmissions determined prior to the cut-off time and after the first DL transmission are considered elements of a set of potential subsequent DL occasions; and a third resource for transmitting an acknowledgment corresponding to the first DL transmission based on the second resource and the set of potential subsequent DL occasions; and transmitting the acknowledgment in the third resource.

In certain embodiments: a fourth resource from the set of potential subsequent DL occasions such that the fourth resource is an earliest valid DL resource after the second resource; a fifth resource from the set of potential subsequent DL occasions such that the fifth resource is a latest valid DL resource before the second resource; and the third resource is determined based on the second resource, the fourth resource, and the fifth resources.

In some embodiments, the third resource is determined to be the second resource if the fifth resource is at most ‘l₁’ time units before the second resource.

In various embodiments, the method further comprises reporting a value of ‘l₁’.

In one embodiment, the third resource is determined to be the earliest valid UL resource that is at most ‘l₁’ time units after the fourth resource.

In certain embodiments, the third resource is no later than ‘l₂’ time units after the second resource.

In some embodiments, the method further comprises receiving an indication indicating whether the third resource is determined based on the fourth resource and the fifth resource in addition to the second resource.

In various embodiments, the method further comprises, in response to the indication indicating that the third resource is determined based on the fourth resource and the fifth resource in addition to the second resource, determining the third resource based on the second resource, the fourth resource, and the fifth resource.

In one embodiment, the method further comprises, in response to the indication not indicating that the third resource is determined based on the fourth resource and the fifth resource in addition to the second resource, determining the third resource based on the second resource and not based on the fourth resource and the fifth resource.

In certain embodiments, the indication comprises a group-common DCI.

In some embodiments, the method further comprises determining a time duration, wherein the indication is applicable for the time duration.

In various embodiments, the time duration is determined to be a time interval between a first time instance and a second time instance, and the first time instance is determined based on a time that the indication is received.

In one embodiment, if a second indication of the same type of the indication is received, the second time instance is determined to be the time that the second indication is received.

In certain embodiments, the method further comprises sending a confirmation indication to a network device in response to receiving the indication.

In some embodiments, the third resource and the fourth resource are in a slot of a reference slot duration.

In various embodiments, the reference slot duration is associated with a longest slot duration among UL and DL transmissions.

In one embodiment, the first DL transmission is associated with a first HARQ process, and the acknowledgement corresponding to a second DL transmission associated with a second HARQ process is sent on an UL resource indicated by a second DCI scheduling the second DL transmission.

In certain embodiments, the cut-off time is determined based on: the second resource; a PDSCH-to-HARQ feedback timing k1; the first resource; an indication; an earliest DCI occurring after the first DL transmission; or some combination thereof.

In some embodiments, the method further comprises determining a set of UL occasions prior to a second cut-off time, wherein the third resource is further determined based on the set of UL occasions.

In one embodiment, an apparatus comprises: a transmitter to transmit a first DL transmission in a first resource, wherein, in response to transmitting the first DL transmission: a second resource is determined based on a first DCI that assigns resources for the first DL transmission; a cut-off time is determined, wherein a set of DL transmissions determined prior to the cut-off time and after the first DL transmission are considered elements of a set of potential subsequent DL occasions; and a third resource is determined for transmitting an acknowledgment corresponding to the first DL transmission based on the second resource and the set of potential subsequent DL occasions; and a receiver to receive the acknowledgment in the third resource.

In certain embodiments: a fourth resource from the set of potential subsequent DL occasions such that the fourth resource is an earliest valid DL resource after the second resource; a fifth resource from the set of potential subsequent DL occasions such that the fifth resource is a latest valid DL resource before the second resource; and the third resource is determined based on the second resource, the fourth resource, and the fifth resources.

In some embodiments, the third resource is determined to be the second resource if the fifth resource is at most ‘l₁’ time units before the second resource.

In various embodiments, the third resource is determined to be the earliest valid UL resource that is at most ‘l₁’ time units after the fourth resource.

In one embodiment, the third resource is no later than ‘l₂’ time units after the second resource.

In certain embodiments, the transmitter further to transmit an indication indicating whether the third resource is determined based on the fourth resource and the fifth resource in addition to the second resource.

In some embodiments, the third resource and the fourth resource are in a slot of a reference slot duration.

In various embodiments, the reference slot duration is associated with a longest slot duration among UL and DL transmissions.

In one embodiment, the first DL transmission is associated with a first HARQ process, and the acknowledgement corresponding to a second DL transmission associated with a second HARQ process is sent on an UL resource indicated by a second DCI scheduling the second DL transmission.

In certain embodiments, the cut-off time is determined based on: the second resource; a PDSCH-to-HARQ feedback timing k1; the first resource; an indication; an earliest DCI occurring after the first DL transmission; or some combination thereof.

In one embodiment, a method at a network device comprises: transmitting a first DL transmission in a first resource, wherein, in response to transmitting the first DL transmission: a second resource is determined based on a first DCI that assigns resources for the first DL transmission; a cut-off time is determined, wherein a set of DL transmissions determined prior to the cut-off time and after the first DL transmission are considered elements of a set of potential subsequent DL occasions; and a third resource is determined for transmitting an acknowledgment corresponding to the first DL transmission based on the second resource and the set of potential subsequent DL occasions; and receiving the acknowledgment in the third resource.

In certain embodiments: a fourth resource from the set of potential subsequent DL occasions such that the fourth resource is an earliest valid DL resource after the second resource; a fifth resource from the set of potential subsequent DL occasions such that the fifth resource is a latest valid DL resource before the second resource; and the third resource is determined based on the second resource, the fourth resource, and the fifth resources.

In some embodiments, the third resource is determined to be the second resource if the fifth resource is at most ‘l₁’ time units before the second resource.

In various embodiments, the third resource is determined to be the earliest valid UL resource that is at most ‘l₁’ time units after the fourth resource.

In one embodiment, the third resource is no later than ‘l₂’ time units after the second resource.

In certain embodiments, the method further comprises transmitting an indication indicating whether the third resource is determined based on the fourth resource and the fifth resource in addition to the second resource.

In some embodiments, the third resource and the fourth resource are in a slot of a reference slot duration.

In various embodiments, the reference slot duration is associated with a longest slot duration among UL and DL transmissions.

In one embodiment, the first DL transmission is associated with a first HARQ process, and the acknowledgement corresponding to a second DL transmission associated with a second HARQ process is sent on an UL resource indicated by a second DCI scheduling the second DL transmission.

In certain embodiments, the cut-off time is determined based on: the second resource; a PDSCH-to-HARQ feedback timing k1; the first resource; an indication; an earliest DCI occurring after the first DL transmission; or some combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a first downlink (DL) transmission in a first resource;
in response to receiving the first DL transmission, determine:
a second resource based on a first downlink control information (DCI) that assigns resources for the first DL transmission;
a cut-off time, wherein a set of DL transmissions determined prior to the cut-off time and after the first DL transmission are considered elements of a set of potential subsequent DL occasions; and
a third resource for transmitting an acknowledgment corresponding to the first DL transmission based on the second resource and the set of potential subsequent DL occasions; and
transmit the acknowledgment in the third resource.

2. The UE of claim 1, wherein:
a fourth resource from the set of potential subsequent DL occasions is determined such that the fourth resource is an earliest valid DL resource after the second resource;
a fifth resource from the set of potential subsequent DL occasions is determined such that the fifth resource is a latest valid DL resource before the second resource; and
the third resource is determined based on the second resource, the fourth resource, and the fifth resources.

3. The UE of claim 2, wherein the third resource is determined to be the second resource if the fifth resource is at most ‘l₁’ time units before the second resource.

4. The UE of claim 3, wherein the at least one processor is configured to cause the UE to report a value of ‘l₁’.

5. The UE of claim 2, wherein the third resource is determined to be the earliest valid uplink (UL) resource that is at most ‘l₁’ time units after the fourth resource.

6. The UE of claim 5, wherein the third resource is no later than ‘l₂’ time units after the second resource.

7. The UE of claim 2, wherein the at least one processor is configured to cause the UE to receive an indication indicating whether the third resource is determined based on the fourth resource and the fifth resource in addition to the second resource.

8. The UE of claim 7, wherein, in response to the indication indicating that the third resource is determined based on the fourth resource and the fifth resource in addition to the second resource, the at least one processor is configured to cause the UE to determine the third resource based on the second resource, the fourth resource, and the fifth resource.

9. The UE of claim 7, wherein, in response to the indication not indicating that the third resource is determined based on the fourth resource and the fifth resource in addition to the second resource, the at least one processor is configured to cause the UE to determine the third resource based on the second resource and not based on the fourth resource and the fifth resource.

10. The UE of claim 7, wherein the indication comprises a group-common DCI.

11. The UE of claim 7, wherein the at least one processor is configured to cause the UE to determine a time duration, and the indication is applicable for the time duration.

12. The UE of claim 11, wherein the time duration is determined to be a time interval between a first time instance and a second time instance, and the first time instance is determined based on a time that the indication is received.

13. The UE of claim 12, wherein, if a second indication of the same type of the indication is received, the second time instance is determined to be the time that the second indication is received.

14. A method performed by a user equipment (UE), the method comprising:
receiving a first downlink (DL) transmission in a first resource;
in response to receiving the first DL transmission, determining:
a second resource based on a first downlink control information (DCI) that assigns resources for the first DL transmission;
a cut-off time, wherein a set of DL transmissions determined prior to the cut-off time and after the first DL transmission are considered elements of a set of potential subsequent DL occasions; and
a third resource for transmitting an acknowledgment corresponding to the first DL transmission based on the second resource and the set of potential subsequent DL occasions; and
transmitting the acknowledgment in the third resource.

15. A base station, comprising:
at least one memory; and
at least one processor coupled with the at least one memory and configured to cause the base station to:
transmit a first downlink (DL) transmission in a first resource, wherein, in response to transmitting the first DL transmission:
a second resource is determined based on a first downlink control information (DCI) that assigns resources for the first DL transmission;
a cut-off time is determined, wherein a set of DL transmissions determined prior to the cut-off time and after the first DL transmission are considered elements of a set of potential subsequent DL occasions; and
a third resource is determined for transmitting an acknowledgment corresponding to the first DL transmission based on the second resource and the set of potential subsequent DL occasions; and
receive the acknowledgment in the third resource.

16. A processor for wireless communication, comprising:
at least one controller coupled with at least one memory and configured to cause the processor to:
receive a first downlink (DL) transmission in a first resource;
in response to receiving the first DL transmission, determine:
a second resource based on a first downlink control information (DCI) that assigns resources for the first DL transmission;
a cut-off time, wherein a set of DL transmissions determined prior to the cut-off time and after the first DL transmission are considered elements of a set of potential subsequent DL occasions; and
a third resource for transmitting an acknowledgment corresponding to the first DL transmission based on the second resource and the set of potential subsequent DL occasions; and
transmit the acknowledgment in the third resource.

17. The processor of claim 16, wherein:
a fourth resource from the set of potential subsequent DL occasions is determined such that the fourth resource is an earliest valid DL resource after the second resource;
a fifth resource from the set of potential subsequent DL occasions is determined such that the fifth resource is a latest valid DL resource before the second resource; and
the third resource is determined based on the second resource, the fourth resource, and the fifth resources.

18. The processor of claim 17, wherein the third resource is determined to be the second resource if the fifth resource is at most ‘l₁’ time units before the second resource.

19. The processor of claim 18, wherein the at least one controller is configured to cause the processor to report a value of ‘l₁’.

20. The processor of claim 17, wherein the third resource is determined to be the earliest valid uplink (UL) resource that is at most ‘l₁’ time units after the fourth resource.
